(19) United States
(12) Patent Application Publication
(10) Pub. No.: US 2025/0378455 A1
(43) Pub. Date: Dec. 11, 2025

(54) SYSTEM AND METHOD FOR BRAND STRATEGY DECISION MAKING

(71) Applicants: Kristiane Hansfed Blomqvist, La Guacima (CR); Maria Gabrieta Pulido, Miami, FL (US)

(72) Inventors: Kristiane Hansfed Blomqvist, La Guacima (CR); Maria Gabrieta Pulido, Miami, FL (US)

(21) Appl. No.: 18/739,320

(22) Filed: Jun. 11, 2024

(51) Int. Cl. G06Q 10/0637; G06Q 10/067; G06V 10/82

(52) U.S. Cl. CPC G06Q 30/02013; G06Q 10/06375; G06Q 10/067; G06Q 30/02017

(57) ABSTRACT

A system and method using multiple machine learning models for generating a brand strategy for brands owned by a business entity comprising correlating brand relationship data between or among core brands and other brands of the business entity to generate a brand sphere and utilizing the brand sphere to generate the brand strategy and the brand strategy for a business offering, extension, expansion, acquisition, or rationalization.

### CROSS REFERENCE TO RELATED APPLICATIONS

The application claims the priority of a provisional Application of U.S. 63/742,216 filed Jun. 9, 2023, the content of which is incorporate herein by reference in its entirety.

### FIELD OF THE DISCLOSURE

The present disclosure relates generally to the analysis of brand identity associations owned by a business entity and more specifically to a system and method that employs multiple types of machine learning for brand strategy decision-making. This technology analyzes an organization's brands using visual cues and strategic filters to develop strategies that maximize business value for offerings, extensions, expansions, acquisitions, or rationalizations. The system is designed to significantly reduce the substantial resources and human bias that currently hinder effective decision-making in brand strategy.

### BACKGROUND OF THE DISCLOSURE

Business organizations invest significant resources in developing brand strategies, akin to business plans, that enhance market rapport and favorability. Brands and trademarks, such as logos and word marks, are critical in building this rapport and fostering goodwill. Effective brand strategies often involve managing a brand portfolio to optimize business value, including decisions on brand extensions, market entry, product innovation, and strategic partnerships. However, these predominantly manual processes rely on extensive research and subjective assessments, making them prone to inaccuracies, time delays, and inefficiencies. These inefficiencies can adversely affect a business entity's profitability, growth, and reputation, highlighting a critical gap in the modernization of brand strategy formulation.

Identifying which brand strategy, a business entity should use for brand protection and expansion is very difficult, costly, and time-consuming. Current methods are not data-driven in an organized fashion, leading to human bias, delays, and subjectivity. Typically, the process requires hiring specialists who manually map a business's brand portfolio by first identifying and gathering all logos and trademarks and then evaluating each brand using various data inputs. This mapping would be followed by a manual assessment of the strategic opportunity e.g. of a new product innovation and what role it should play for the company and might involve extensive research. There are many books written on the subject of manually analyzing brand portfolios, developing brand strategies, and deciding on which strategy would produce the maximum value, e.g. by David Aaker and Jesper Kunde among others.

Accordingly, there is need for a solution to at least one of the aforementioned problems. For instance, there is an established need for reducing the costs, time, resources needed, and errors associated with analyzing, developing, and deciding on brand strategy options. The integration of machine learning models into brand strategy development remains markedly underexplored. Such technology promises to streamline brand strategy and portfolio management, enabling businesses to identify risks and opportunities more effectively and make timely, data-driven decisions that can significantly enhance profitability and growth.

### SUMMARY OF THE DISCLOSURE

Certain embodiments disclosed herein comprise a method and system that facilitates brand strategy development by employing machine learning to analyze and optimize a business's brand portfolio. This method involves a brand sphere model that assesses relationships among brands relative to a core brand. By processing visual data and user-defined cues through advanced neural networks, the system categorizes brands and generates strategic insights based on comprehensive data analysis. This automated approach minimizes human bias by leveraging algorithmically derived correlations between visual identifiers and brand performance, leading to data-driven strategy recommendations that detail the strengths, weaknesses, and optimal strategies for brand enhancement.

Certain embodiments disclosed herein also include a system for method for analyzing a business organization's brand portfolio, determining the relationship among or between the business entity's brands in relation to its core brand using a brand sphere. The system comprises an interface to a network for receiving a request to generate a brand strategy and an input of data comprising visual cues for the brands, the visual cues comprising elements representing the brand or brands; and a processing unit configured to: accept a request to determine the relationship among or between a business entity's brand, accept data input, analyze the input, correlate visual cues from the brands, determine the relationship, produce a brand sphere, and generate a brand strategy comprising the analysis results and detailing the brand portfolio's strengths and weaknesses.

In general, in one or more aspects, the disclosure relates to a method of training machine learning models to generate a brand strategy using visual cues and data-based answers to questions. The brand strategy generator is trained to generate a brand portfolio analysis, brand sphere, and brand strategy from visual cues and data inputted into the system. An augmented brand strategy generator is trained to generate an augmented image brand rank from the image brand class. Predicted brand strategies for maximizing brand value for a given brand or product opportunity are generated from the augmented image brand rank within the context of a brand sphere. A neural network model is trained to generate a predicted augmented brand strategy, also called a brand sphere, which predicts preferred value for a brand or product opportunity for a business entity.

In general, in one or more aspects, the disclosure relates to a system comprising one or more processors, one or more memories, a training application, and a server application. The training application is stored on the one or more memories, executes on the one or more processors, and is configured for: training a brand strategy model to generate a brand sphere and brand strategies from visual cues and inputted data, training an augmented brand strategy model to generate an augmented brand strategy and brand sphere from the visual cues and inputted data. The server application is stored on the one or more memories, executes on the one or more processors, and is configured for: generating, with a recommendation engine, a brand strategy recommendation from visual cues and inputted data using a machine learning model that includes the neural network model, and displaying the recommendation to a device.

In general, in one or more aspects, the disclosure relates to a method of classifying brands associated with a business entity and determining a brand strategy, and generating a brand strategy that comprises brand portfolio analysis information and recommendations for associating a new brand with a core brand owned by the business entity. A neural network model is trained to generate a maximum value predicted augmented brand strategy from the predicted brand strategy generated by the system and/model. A brand strategy recommendation is generated with a recommendation engine from visual cues and inputted data using a machine learning model that includes the neural network model. The recommendation is displayed on a device.

These and other objects, features, and advantages of the present disclosure will become more readily apparent from the attached drawings and the detailed description of the preferred embodiments, which follow. Other aspects of the invention will be apparent from the following description and the appended claims.

### BRIEF DESCRIPTION OF THE DRAWINGS

The preferred embodiments of the disclosure will hereinafter be described in conjunction with the appended drawings provided to illustrate and not to limit the disclosure, where like designations denote like elements, and in which:

FIG. 1 illustrates a flow chart in accordance with a disclosed embodiment of the present disclosure;

FIG. 2 illustrates a flow chart in accordance with a disclosed embodiment of the present disclosure;

FIG. 3 illustrates a diagram of a brand sphere in accordance with a disclosed embodiment of the present disclosure;

FIG. 3.1 illustrates examples of brand spheres in accordance with a disclosed embodiment of the present disclosure;

FIG. 3.2 illustrates examples of brand spheres in accordance with a disclosed embodiment of the present disclosure;

FIG. 4 illustrates an exemplary embodiment of a decision flowchart in accordance with a disclosed embodiment of the present disclosure;

FIG. 5 illustrates an exemplary embodiment of a decision flowchart in accordance with a disclosed embodiment of the present disclosure;

FIG. 6 illustrates an exemplary embodiment of a decision flowchart in accordance with a disclosed embodiment of the present disclosure;

### DETAILED DESCRIPTION

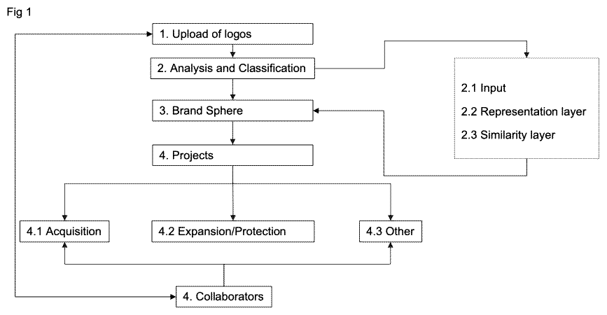

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the disclosure as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward system and method for brand strategy decision making. In general, embodiments of the disclosure train and use machine learning models to identify relationships between or among brands owned by a business entity to generate recommendations for brand strategies.

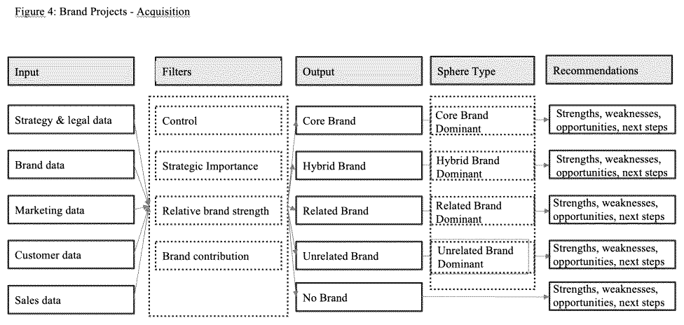

A training application uses visual cues of multiple business entities to train multiple machine learning models to determine the relationship among or between the brands owned by a business entity, i.e., to identify the brand strategy and generate brand spheres. The brand spheres provide an illustration of the relationship between or among the core brand and other brands i.e. target brands owned by a business entity. Generating the brand sphere is performed by inputting the business entity's logos into the system and analyzing the logos for visual cues using the machine learning models. (See FIG. 1). Once the brand sphere is produced, a list of projects is generated to collect data input needed to generate multiple brand protection and/or expansion strategies (See FIG. 1). A relative brand strength filter comprised of control, strategic importance, relative brand strength and brand contribution can be applied to the data inputted to generate output comprising brand strategy results (See FIG. 4).

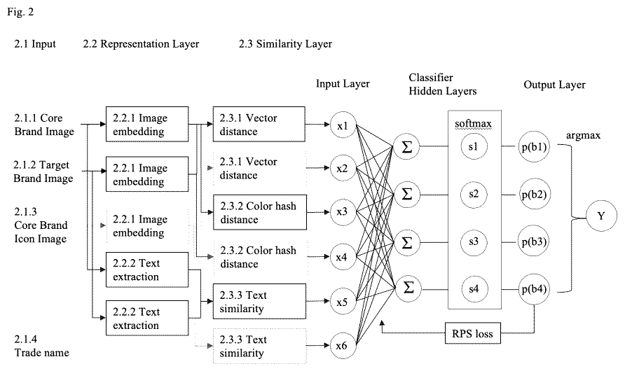

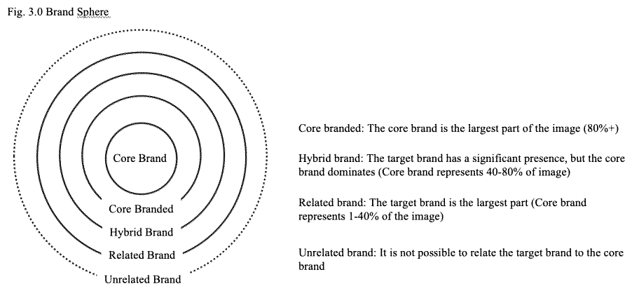

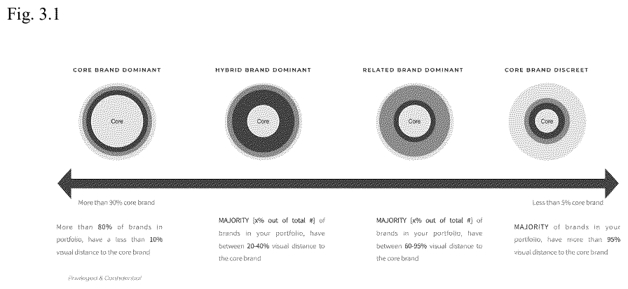

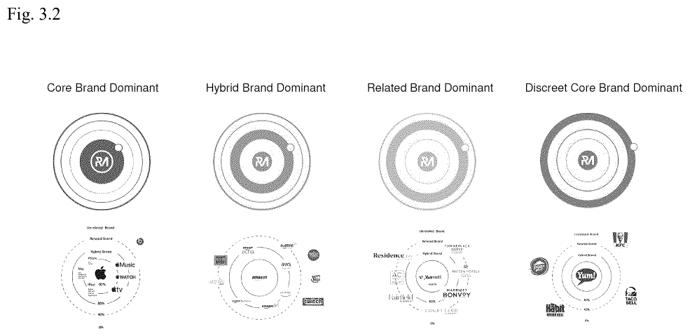

The machine learning models extract text from the inputted images and embed the images (See FIG. 2). The machine learning model analyzes the similarity of the target brand with the core brand and produces a similarity analysis result. The machine learning model associates a vector distance using Euclidean Distance to the similarity analysis result and produces an output layer that arranges the target brands and the core brand in a concentric display, with the core brand being in the center. The further the target brand is away from the core brand, the less the other brand is perceived to be associated with the core brand. (See FIGS. 3.0, 3.1, and 3.2). The brand spheres will display information derived from correlating the business entity's core brand or brands with target brand or brands owned by the business entity and be used to generate a brand strategy that comprises the strengths, weaknesses, opportunities and risks of the brand portfolio. The brand strategy may be determined by a weighted combination of input data and visual cues derived from the logos and brands owned by the business entity.

The Brand Sphere: The neural network module or machine learning module can sort and categorize a group of brands using visual cues extracted from brand images inputted into the system to determine their brand strategy and relationship to a core brand (which can be predefined by the user). The machine learning modules can sort the brands into 4 different categories (Sec FIG. 3.0). Based on the composition of the categories, the machine learning modules can identify the type of brand portfolio that a business organization owns along with its strengths, weaknesses, opportunities and risks.

The Brand Projects: A method for making brand strategy decisions intuitive, easy to follow and data driven (See FIG. 4-7).

The Collaborative Platform: The system can be a platform where teams can collaborate when making brand strategy decisions and share knowledge.

FIGS. 1-3 disclose a trained machine learning model or neural network model for brand strategy identification using logo images. The model sorts and categorizes a group of brands/logos owned by a business entity using visual cues extracted from brand images inputted into the system to determine their brand strategy based on their relationship to a core brand/logo (which can be predefined by the user). The model sorts the brands/logos into 4 different categories. Based on the composition of different categories, the model identifies the type of brand portfolio that a company has and its associated strengths, weaknesses, opportunities and risks, and displays the results generated from the model. (The Brand Sphere).

FIG. 1 illustrates a flow chart in accordance with a disclosed embodiment of the present disclosure. In one embodiment, the flow chart illustrates the brand sphere model and its linkage to the brand strategy. The model is initiated by a user uploading a portfolio of logos (target brand) and identifying the core brand. The model analyzes the similarity of each target brand with the core brand and produces a similarity analysis result using a vector distance, color hash distance and text similarity (See FIG. 2). The model produces an output layer that arranges the target brands and the core brand in a concentric display, with the core brand being in the center. Once the brand sphere is generated, the model produces a list of projects which directs the user to input data in a consistent format based on a predefined flow of questions passing a predefined number of filters in order to obtain a brand strategy recommendation. The model allows for further modification of the brand sphere by collaborators to correspond with updated brand strategy decision

FIG. 2 illustrates a detailed flow chart in accordance with a disclosed embodiment of the present disclosure. This embodiment showcases the operational flow of a training application specifically designed to analyze and correlate brand relationships using visual data inputs. The process begins with the input of various brand-related images including core brand images, target brand images, core brand icons, and trade names—for example, using Amazon's logo as the core brand image and the AWS logo as the target brand image.

The first step in the process involves the representation layer, where each input image undergoes a series of analyses to extract meaningful data. This includes:

Image Embedding: Utilizing a pre-trained MobileNetV2 model, each image is processed to extract deep features that capture the essence of the brand's visual identity. The choice of MobileNetV2 is due to its efficiency in handling image data with reduced computational overhead, making it ideal for real-time processing.

Text Extraction: Parallel to image embedding, text extraction is performed using the keras-ocr model, which is adept at recognizing and interpreting textual content within images. This step ensures that any textual elements, such as slogans or brand names within logos, are identified and used in the analysis.

Following the initial data extraction, the process moves to the similarity layer. Here, the extracted data is analyzed to assess the relationships between the core brand and target brands based on:

Vector Distance: Measuring the Euclidean distances between feature vectors obtained from image embeddings to quantify visual similarity.

Color Hash Distance: Assessing color similarities which capture the aesthetic and stylistic correlations between brands.

Text Similarity: Employing the Ratcliff/Obershelp pattern recognition algorithm to compare textual similarities, enhancing the overall accuracy of brand alignment assessment.

The output of the similarity layer feeds into the decision-making module, which employs a neural network to classify the relationships into predefined categories within the brand sphere, as detailed in FIG. 3. This classification is based on the computed similarities, where each brand is positioned in a concentric display around the core brand. The proximity to the core brand in this display directly relates to the degree of brand alignment, ranging from ‘Core Branded’ to ‘Unrelated Brand.

This flowchart encapsulates the systematic approach of converting raw brand images into actionable brand strategy insights, facilitating data-driven decision-making that minimizes human bias and enhances strategic alignment.

FIG. 3.0 illustrates a diagram of a brand sphere in accordance with a disclosed embodiment of the present disclosure. In one embodiment the diagram shows the brand sphere comprises of four levels for classifying brand strategy corresponding with the output layers p(b1)-p(b4) as shown in FIG. 2: Core branded: The core brand was the largest part of the target brand image. Hybrid brand: The target brand has a significant presence, but the core brand dominates. Related brand: The target brand was the largest part of the image. Unrelated brand: It was not possible to relate the core brand from the image of the target brand. The model can identify strengths, weaknesses, opportunities and risks based on the summary classification.

FIG. 3.1 illustrates examples of brand spheres in accordance with a disclosed embodiment of the present disclosure. In one embodiment the examples show how the model can determine the business strategy for a business unit based on the visual cues from the logos. For example, if the business unit has majority core branded logos, it's strategy will be core brand dominant, if it has majority hybrid brand logos, it's strategy will be hybrid brand dominant, if it has majority related brand logos, it's strategy will be related brand dominant and if it has majority unrelated brand logos, it's strategy will be unrelated brand dominant.

FIG. 3.2 illustrates examples of brand spheres in accordance with a disclosed embodiment of the present disclosure. In one embodiment the examples identify the brand strategies of leading companies based on visual cues. For example, Apple has a core brand dominant strategy, Amazon has a hybrid brand dominant strategy, Marriott has a related brand dominant strategy and Yum! Brands has a unrelated brand dominant strategy.

FIGS. 4-6 disclose a method for streamlining brand strategy decision making which is informed by the machine learning model or neural network (The Brand Sphere). The method directs the user to input data in a consistent format based on a predefined flow of questions which passes a predefined number of filters in order to obtain a brand strategy recommendation.

FIG. 4 illustrates an exemplary embodiment of a decision flowchart in accordance with a disclosed embodiment of the present disclosure. In one embodiment, the decision flowchart illustrates the brand strategy decision-making model for business unit acquisitions. The decision flowchart defines the required input comprised of strategy and legal data, brand data, marketing data, customer data and sales data; the strategic filters comprised of control, strategic importance, relative brand strength and brand contribution; the brand strategy output comprised of core brand, hybrid brand, related brand, unrelated brand and no brand; and finally the recommendations based on sphere type comprised of strengths, weaknesses, opportunities and next steps.

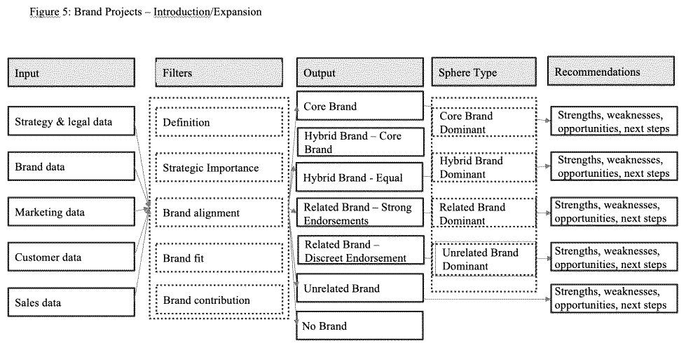

FIG. 5 illustrates an exemplary embodiment of a decision flowchart in accordance with a disclosed embodiment of the present disclosure. In one embodiment, the decision flowchart illustrates the brand strategy decision-making model for business unit product introductions and market expansions. The decision flowchart defines the required input comprised of strategy and legal data, brand data, marketing data, customer data and sales data; the strategic filters comprised of definition, strategic importance, brand alignment, brand fit and brand contribution; the brand strategy output comprised of core brand, hybrid brand—core brand, hybrid brand—equal, related brand—strong endorsements, related brand—discrete endorsements, unrelated brand and no brand; and finally the recommendations based on sphere type comprised of strengths, weaknesses, opportunities and next steps.

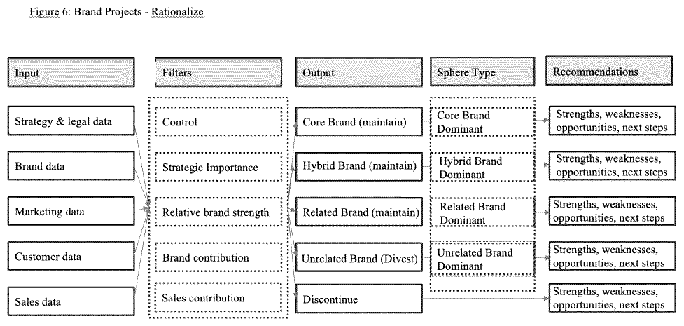

FIG. 6 illustrates an exemplary embodiment of a decision flowchart in accordance with a disclosed embodiment of the present disclosure. In one embodiment, the decision flowchart illustrates the brand strategy decision-making model for business unit brand divestiture and rationalization. The decision flowchart defines the required input comprised of strategy and legal data, brand data, marketing data, customer data and sales data; the strategic filters comprised of control, strategic importance, relative brand strength, brand contribution and sales contribution; the brand strategy output comprised of core brand (maintain), hybrid brand (maintain), related brand (maintain), unrelated brand (divest) and no brand (discontinue); and finally the recommendations based on sphere type comprised of strengths, weaknesses, opportunities and next steps.

Trademarks, including logos, have high importance in today's marketing world. Products, companies and organizations invest vast amounts of resources to build goodwill for their trademarks, including logos. A logo can reflect the business entity's business strategies through its position within the business unit's brand architecture. According to this, understanding what relationship brand logos have with a core brand of a business entity is of vital importance to ensure that a business entity's brand strategy aligns with, and supports, its business objectives when making brand portfolio decisions. Determining what the brand strategy is between the logo of a core brand and another brand owned by the business entity can have great value and drive profitability for a business entity. The present system and method determine the brand strategy between a core brand and other brands and generate a brand sphere that categorize the brands in four categories: Core Branded, Hybrid Brand, Related Brand and Unrelated Brand, as defined in FIGS. 3. 3.1 and 3.2.

The term brand can be defined broadly as all the expectations and associations evoked from experience with a company or its offerings. Logos, taglines, advertising jingles, spokespeople or packaging are part of the representation of the brand. Brand strategy (or brand architecture) is the way in which companies organize, manage and go to market with their brands. Brand strategy is often the external “face” of business strategy and must align with and support business goals and objectives. Different business strategies may require different brand strategies and brand architectures which informs brand portfolio management. The present disclosure teaches how to identify a brand strategy that will be profitable and build reputation from the logos for a large part of the brands owned by a business entity.

A multi-class machine learning system and method are described herein, where function F (Bcore, Btarget) that maps the brands Bcore and Btarget to the classes b1, b2, b3, and b4.

$$F ( Bcore , Btarget ) = argmax ( p ( b 1 ) , p ( b 2 ) , p ( b 3 ) , p ( b 4 ) ) , \qquad ( 1 )$$

where, Bcore the core brand, Btarget another brand, and p(b1), p(b2), p(b3), p(b4) the probabilities Btarget be core branded, hybrid brand, related brand and unrelated brand with relation to Bcore, respectively.

The RPS function or Ranked Probability Score can be a squared measure that compares the estimated cumulative density function of a probabilistic ranked classification with the actual cumulative density function of the corresponding observation. Under a discrete scenario of possible outcomes, the RPS formula comprises:

$$RPS = \frac{1}{N} {\sum }_{n = 1}^{N} [ {\sum }_{b = 1}^{4} {( {y\_pred}_{b} ( i ) - {y\_true}_{b} ( i ) )}^{2} ]$$

where, N is the number of rows in the dataset, b is the brand class, y pred is the predicted probability and y true represents the real value.

The system and method can employ this function to determine an order between the classes given by the magnitude of the influence of the core brand in the target brand. In other words, a hybrid brand can have more influence from the core brand than a related one, and in turn, a related brand can have more presence than an unrelated one.

RPS is sensitive to distance which means that a wrong classification is increasingly penalized the more its predictions differ from the actual outcome.

RPS aids in generating predictions close to the current brand level, besides the fact of hitting the target class of the brand level with the highest point-probability estimate.

### Experimental Setting

For the initial testing of the model a quality dataset was produced from 286 images from 26 different companies that made up a total of 260 tagging examples. For the labeling process, 3 juries were employed. Simple criteria for labeling were defined in line with FIG. 3:

Core branded: The core brand was the largest part of the target brand image.

Hybrid brand: The target brand has a significant presence, but the core brand dominates. Related brand: The target brand was the largest part of the image

Unrelated brand: It was not possible to relate the core brand from the image of the target brand.

The final label of the relationship between two brands was decided by majority. However, a label closure criterion using the Fleiss′ kappa2 agreement coefficient greater than 80% was employed.

To overcome any errors associated with a small number of brand examples being used, two data augmentation strategies were employed. Examples of Unrelated Brands were generated by crossing the core brand of a company with logos of brands of other companies. In this way, the result of the relationship of this combination is a brand that had no relationship. On the other hand, image transformations were employed, such as rotations to generate different images of the same logo. Applying the same transformation to two logos does not change the relationship between them is an assumption that was employed.

Following the experimental setting, a large quality test dataset was built by using a discretized RPS (dRPS) to measure performance. The difference with the RPS that we use for training is that the predicted value was discrete, not probabilistic. After establishing the probabilities that a brand has of being of each of the classes, a decision can be made, and the discrete RPS was used to measure the error of that decision.

### Approach

Determining the brand strategy for a target brand based on its relationship with a core brand was a difficult process, since it involved not only aspects of shapes but also text, calligraphy, color gamma and in some cases extra knowledge of the company that the consumer has.

Each of these aspects constituted a representation. Each representation was processed by a different data processor as shown in FIG. 2.

Once the representations were generated, the distances between them were calculated, to obtain a feature. For example, the distance between the text of the core brand with the text of the target brand was calculated.

Finally, a vector of features X=<x1, x2, . . . x6>which constitutes the input data to a single-layer neural network that has as output the probabilities p(b1), p(b2), p(b3), p(b4), from Equation 2 was generated.

### Representation Layers

Representations were used to extract features from logos as shown in FIG. 2, 2.2. Two different types of representations were employed: images embeddings as shown in FIG. 2, 2.2.1 and text extraction as shown in FIG. 2, 2.2.2. Each of these is described below.

### Image Embedding

For the generation of embeddings a pre-trained model MobileNetV2 was used. MobileNet is a class of CNN (Convolutional Neural Network) that was open-sourced by Google, and therefore, this gives us an excellent starting point for training our classifier. MobileNet uses depthwise separable convolutions. It significantly reduces the number of parameters when compared to the net-work with regular convolutions with the same depth in the nets. This results in lightweight deep neural networks.

The procedure or method employed was to pass the image of the logo through the MobileNetV2 network and to retrieve the penultimate layer, which is a global average pool layer. This layer contained a 1024-dimensional vector that represents valuable image features for use in the system and method described herein.

### Text Extraction

For text extraction, keras-ocr. Keras-ocr, a pre-trained model, was employed and is the keras implementation of a Convolutional Recurrent Neural Network for text recognition. The network extracts text from an image, and outputs both text bounding boxes and text labels in one forward pass.

MobileNet was utilized with this network to generate the extracted text. Bounding boxes were not used but can optionally be used.

### Similarity Layer

Three difference similarity measures were used between our representations as shown in FIG. 2, 2.3. For image embeddings, the Euclidean Distance, the most direct way to measure the distance between two vectors, was employed (FIG. 2, 2.3.1). For color-hash, Hamming Distance was employed (FIG. 2, 2.3.2). Finally, for text similarity, Ratcliff/Obershelp pattern recognition algorithm was employed. (FIG. 2, 2.3.3).

### Additional Inputs

The image of the core brand icon comprised text (FIG. 2, 2.1). For example, in Apple company the apple or in Ford the blue oval with the inscription “Ford”. If the core brand icon comprised the business entity name and not the trademark for the business entity, e,g., “The Walt Disney Company” is commonly known as “Disney” or “The Ford Motors Company” as “Ford”, the text was changed to the trademark for business entity as shown in FIG. 2.

### Proof of Concept (PoC)

Exemplary results achieved for the experiment performed and shows the results of RPS (probabilistic) and dRPS (discretized RPS) for each possible configuration. In the “random,” the results that a uniform distribution would give for RPS, as well as the results that choosing a random class for dRPS would give, can be seen. This was used to determine the contribution of the model to the solution of the problem.

PoC implementation showed applying the system and method described herein to identify the brand strategy works and within certain degree of effectiveness using only the images of the logos.

Following the PoC implementation, a new large quality dataset was built to further improve performance of the model.

Once a Brand Sphere has been generated, brand decisions can be made by inputting new data into the system or answering questions the system has either generated or had stored. The system allows brand strategy decisions to be anywhere, anytime, from their mobile, tablet, computer, or laptop. When the system is launched, the method of generating a brand strategy begins for brand protection and/or expansion (See FIG. 4.0, 4.1, 4.2.) The system can be interactive and will display questions, such as a question asking what type of decision the system should make. The system can produce a series of questions that a user should answer to get a recommended decision for the type of decision the user wants the system to make. The questions may address parameters such as strategic importance, brand fit, target, and relative brand strength. The user can easily and inexpensively evaluate several different scenarios before making a final decision. This is significantly different to today where the company would not have access to the same type of consistent streamlined process. Depending on the company, they may make the decision using specialist or external advisors and different types of research. The method encourages the business entity to be consistent and transparent in its rationale for decision-making. By reinforcing consistency and transparency, the method drives the business entity to increase collaboration and productivity, as well as business value.

The method can comprise the following steps:
Step 1: Training an machine learning or neural network model to identify the brand strategies of a target brands based on their relationship to a pre-determined core brand using visual cues
Step 2: Sort and classify target brands based on their brand strategy to determine the brand strategy for the core brand identifying strengths, weaknesses, opportunities and risks
Step 3: Productifying the decision-making brand strategy process for brand protection and brand expansion
Step 4: Developing a prototype brand strategy
Step 5: Developing a web-based app that integrates the machine learning or neural network model through an API

A web based application can be employed to perform the method for making brand strategy decisions that is intuitive, streamlined and data driven. (The Brand Projects)

The system can be a platform where teams can collaborate on making brand strategy decisions and share knowledge. (The Collaborative Platform). Each user can invite collaborators to their account and the collaborators can create projects and view their teammates on-going and completed projects. This fosters transparency and consistency in decision-making and a more productive team environment. This is different from today where teams do not have a platform to collaborate when generating a brand strategy decisions and where the rationale and the decisions as a result often reside with a few individuals.

Alternative embodiments are contemplated in which one or more in which the system and method can comprise:

An expanded data set with a larger number of diverse images that can continuously enhance the system's performance and enable it to perform more complex predictions. This can be achieved by collecting more labeled data or considering the creation of synthetic examples.

An expanded isolated dataset with screenshots and poorly cropped images to further train the system to identify patterns amongst such images.

An expanded isolated dataset with diverse related images to train the system to identify patterns within a given level of the brand sphere.

Implementing an API to external sources and Large Language Models to train the system to incorporate brand and financial performance measure to predict augmented maximum brand value for a brand sphere and identifying brand strategy opportunities.

Implementing an API to external sources and Large Language Models to train the system to predict brand strategy recommendations and creation for a brand strategy opportunity in a brand sphere.

Implementing an API to external sources to train the system to search for target logos based on relative association to a predefined core brand on company databases, search engines and Large Language Models.

Applying basic data augmentation techniques (such as translations, rotations, and zooms) to pairs of input logos, making multiple predictions (one for each transformed pair), and aggregating statistical measures from these predictions, can increase robustness and provide a more reliable and accurate result.

Combining relevant features from a logistic regression model and fine-tuning the weights of a convolutional neural network can result in improved performance. Creating an ensemble of models that leverage the strengths of different algorithms may enhance the overall predictive capability.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption.

The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

What is claimed is:

1. A system comprising:
one or more processors;
one or more memories;
a training application stored on the one or more memories, executing on the one or more processors, and configured for:
training a brand strategy model to generate a brand relationship correlation from visual data inputs
training an augmented brand strategy model to generate a brand sphere from the brand relationship correlation,
generating the brand strategy from the brand sphere using a brand project model, and
training a neural network model to generate the brand strategy from the visual data inputs; and
a server application stored on the one or more memories, executing on the one or more processors, and configured for:
generating, with a recommendation engine, a recommendation from image data using a machine learning model that includes the neural network model, and guided predefined and consistent data-input, and

2. The system of claim 1, further comprising using
$$RPS = \frac{1}{N} {\sum }_{n = 1}^{N} [ {\sum }_{b = 1}^{4} {( {y\_pred}_{b} ( i ) - {y\_true}_{b} ( i ) )}^{2} ]$$
to classify the visual data inputs and generate the brand sphere.

3. The system of claim 1, further comprising displaying the brand strategy to a device, wherein the display is interactive, each portion of the brand strategy being clickable, and providing detailed information about the portion of the brand strategy when clicked.

4. A system comprising:
one or more processors;
one or more memories;
a training application stored on the one or more memories, executing on the one or more processors, and configured to generate a brand sphere, wherein a neural network is employed to generate the brand sphere.

5. The system of claim 4, further comprising using RPS to determine the brand strategy for a target brand using visual cues to determine its relationship to a predefined core brand identifying it as either core branded, hybrid brand, related brand or unrelated brand.

6. The system of claim 4, further comprising using RPS to classify the visual data inputs and generate the brand sphere.

7. The system of claim 4, wherein the classified visual data inputs are further utilized to enhance search functionalities within a database, enabling the retrieval of related visual content based on the classification derived from the neural network.

8. A method for generating a brand strategy, wherein the method comprises the steps of:
generating a brand sphere using multiple machine learning types;
producing a brand strategy assessment comprising strength, weaknesses, opportunities and risks;
entering data into a recommendation system to produce a brand strategy recommendation; and
comparing the brand strategy recommendation to the brand sphere; and
producing a final brand strategy recommendation.
